(19) United States
(12) Patent Application Publication
(10) Pub. No.: US 2001/0028760 A1
(43) Pub. Date: Oct. 11, 2001

(54) Methods and apparatus for compensating chromatic and polarization mode dispersion

(76) Inventor: Henry H. Yaffe, Reisterstown, MD (US)

Correspondence Address: YAFO NETWORKS, INC., 1340 F CHARWOOD RD., HANOVER, MD, 21076, US

(21) Appl. No.: 09/799,218

(22) Filed: Mar. 5, 2001

Related U.S. Application Data
(60) Provisional application No. 60/186,742, filed on Mar. 3, 2000.

(51) Int. Cl. G02B 6/26

(52) U.S. Cl. 385/27; 385/39; 385/11

(57) ABSTRACT

Integrated and stand-alone methods and apparatus for adaptively compensating for DGD, SOPMD, and CD in optical communication networks are provided. One apparatus includes at least three optical compensators that are optically coupled together in series and a feedback controller. Each compensator includes a variable optical controller that is optically coupled in series to a birefringent element. An optical communication network is also provided that at least includes an optical transmission line, at least two network terminals, and at least one static compensation module. At least one terminal includes an optical demultiplexer that is coupled to that element, a plurality of λ-compensators, and, optionally, a static optical dispersion compensation element.

### CROSS-REFERENCE TO RELATED APPLICATIONS

This claims priority under 35 U.S.C. § 119(e)(1) to U.S. Provisional Patent Application No. 60/186,742, filed Mar. 3, 2000, which is hereby incorporated by reference in its entirety.

### FIELD OF THE INVENTION

The present invention relates to methods and apparatus for compensating chromatic and polarization mode dispersion in optical signals, and particularly to simultaneous compensation of such dispersion in optical fiber communication systems.

### BACKGROUND OF THE INVENTION

Chromatic dispersion (hereinafter, “CD”) is a type of dispersion that affects the transmission of optical pulses in an optical fiber. CD occurs because different wavelengths propagate through optical fiber at different speeds. Thus, a single pulse of light of a certain bandwidth is broadened by the time it reaches its destination terminal. Such broadening can significantly degrade the quality of the optical bit. And, as a result, an optical receiver at a terminal of a communication system may not be able to reliably decode the propagated optical signal, especially at high data transmission rates.

In addition to CD, polarization mode dispersion (hereinafter, “PMD”) is another type of dispersion that affects the transmission of optical pulses in optical fibers. Like CD, PMD also limits optical fiber data transmission, especially over long distances and at high bit rates, such as 10 Gigabits per sec (hereinafter, “Gbs”) and above. PMD is caused by variations in birefringence along the optical path that causes the orthogonal optical signal polarization modes to propagate at different velocities. The primary cause of PMD is the asymmetry of the fiber-optic strand. Fiber asymmetry may be inherent in the fiber from the manufacturing process, or it may be a result of mechanical stress on the deployed fiber. Environmental changes are dynamic and statistical in nature, and are believed to result in PMD changes that can last for variable periods of time and vary with wavelength, with the potential for prolonged degradation of data transmission.

Thermal and mechanical effects, such as diurnal heating and cooling, vibration from passing vehicles, fiber movement in aerial spans, and cabling disturbances by craftspersons (e.g., during patch panel rerouting) have all been shown to cause first and higher order PMD. For example, as shown in FIG. 1, optical pulse 110, which has no dispersion, can be transformed to pulse 120, which displays both first and second order PMD. These effects are known to momentarily increase the PMD in a fiber span and briefly affect the transmission quality of an optical signal. Because these effects are sometimes momentary, they are hard to isolate and diagnose. In fact, these types of problems are sometimes known as “ghosts” because they occur briefly and mysteriously, and cannot be replicated during a system maintenance window.

In long fiber spans, enough PMD can accumulate such that bits arriving at the receiver begin to interfere with others, degrading transmission quality. This effect becomes more pronounced as transmission rates get higher (and bit periods get shorter). Generally, PMD exceeding ten percent of the bit period is considered detrimental. At 10 Gbs, the bit period is 100 psecs, which implies that any span that exhibits PMD greater than 10 psecs may be “PMD-limited.” This generally only occurs in extraordinarily long spans, and those incorporating older fiber.

To date, spans deploying 10 Gbs rates have been specially selected or “link-engineered” to low PMD fibers. As the 10 Gbs data transmission rate standard becomes more prevalent, however, PMD challenged fibers must be deployed, or lit, and specialized engineering resources may become an alternative, though cost prohibitive. PMD is expected to be a significant and growing concern in systems transmitting information at 40 Gbs and higher. For example, at 40 Gbs, the PMD tolerance is only about 2.5 psecs. At this transmission rate, every span is potentially PMD-limited.

Together PMD and CD deleteriously affect the received signal quality and increase the bit error rate of a communication system.

Typically, compensation for PMD and CD were focused on separately. First order PMD can be compensated with a one or two-section arrangement of optical fiber. In this two-section approach, the fast axis of one section is aligned with the slow axis of the other. While this arrangement compensates for the overall differential group delay (hereinafter, “DGD”) of the optical signal, the CD problem is not solved by this two-section approach.

Although CD is substantially static in time, CD is substantially wavelength-dependent. Second order PMD (hereinafter, “SOPMD”) generally includes two components referred to as: (1) depolarization and (2) polarization-dependent chromatic dispersion for its CD-like broadening of the pulse. Thus, one of the SOPMD components behaves like CD.

FIG. 2 shows active feedback PMD compensator 200, which includes two variable polarization controllers 205, two birefringent elements, such as polarization maintaining fibers (hereinafter, “PMFS”) 210, and feedback controller 220. Detector/receiver 215 includes at least a photodetector that converts an optical signal into an electrical one and, as the indicated, can either be incorporated into a receiver or can be part of the feedback controller (not shown).

Each of controllers 205 can include one or more polarization rotators, one or more polarization retarders, or a combination of rotators and retarders. Thus, controller 205 can be constructed from, for example, a lithium niobate crystal, a lanthanum modified lead zirconate titanate (hereinafter, “PLZT”) ceramic, or a stack of liquid crystal cells, for example, to allow limited or endless polarization control. For endless control, three or more (e.g., four) separately controlled active liquid crystal cells can be used. Such controllers are capable of converting an optical signal's polarization state into a desired output polarization state with substantially continuous tunability. If only limited control is required, a controller can include, for example, one active liquid crystal cell and two quarter wave plates.

Birefringent elements (e.g., PMFs) serve as a differential delay line between the polarization controllers. The light is detected, independent of polarization, at an optical receiver after the last PMF or via an optical tap from a detector after the last PMF, to provide a detected RF signal. A feedback controller subsequently develops feedback control signals to control the polarization controller.

It is known that for long distances or high bit rates, CD compensation can be accomplished by appropriate cable design (i.e., dispersion managed cables) or by dispersion compensation at mid-span amplifier modules. These modules, however, are not tunable and only compensate for dispersion over spans of a particular length (e.g., 80 km) and only for specific optical fiber types (e.g., NZDSF).

Although compensator 200 compensates for first order PMD (i.e., DGD), it does not compensate for CD or SOPMD.

It would therefore be desirable to provide methods and apparatus for adaptively compensating for DGD, SOPMD, and CD.

It would also be desirable to provide methods and apparatus for adaptively compensating for DGD, SOPMD, and CD over long distances.

It would be further desirable to provide integrated and stand-alone methods and apparatus for adaptively compensating for DGD, SOPMD, and CD in optical communication networks.

### SUMMARY OF THE INVENTION

It is therefore an object of this invention to provide apparatus and methods for compensating DGD, SOPMD, and CD.

It is also an object to provide methods and apparatus for adaptively compensating for DGD, SOPMD, and CD over long distances.

It is a further object to provide integrated and stand-alone methods and apparatus for adaptively compensating for DGD, SOPMD, and CD in optical communication networks.

According to one aspect of this invention, the apparatus includes at least three optical compensators that are optically coupled in series together and a feedback controller. Each compensator includes a variable optical controller that is optically coupled in series to a birefringent element. The feedback controller can either include or be coupled to a photodetector. The controller receives the electrical signal generated by the photodetector and is coupled to each of the compensators for providing at least one feedback control signal to each of the compensators.

In accordance with another aspect of this invention, an optical communication network is provided that at least includes an optical transmission line, at least two network terminals linked by the transmission line, and at least one static compensation module along the transmission line. At least one of the terminals includes a fixed, preferably broadband, optical dispersion compensation element, an optical demultiplexer that is coupled to that element, and a plurality of λ-compensators in optical series and downstream from the compensation element and the optical demultiplexer.

The static compensation modules are positioned along the optical transmission line. Each of the static compensation modules can include an optical amplifier and a dispersion compensation element. In another embodiment according to this invention, one or more of the terminals can be used as mid-span terminals in an ultra-long network. In this case, at least one static compensation module can be placed on either side of the mid-span terminal.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which

FIG. 1 shows an illustrative optical pulse before and after it undergoes first and second order PMD;

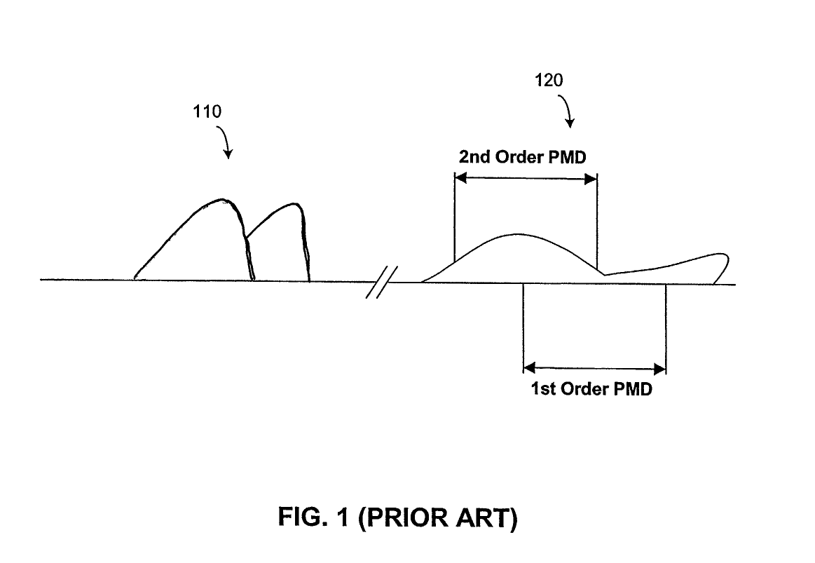

FIG. 2 shows a conventional PMD compensator including two optical compensation stages;

FIG. 3 shows an illustrative PMD compensator that includes three optical stages for compensating DGD, SOPMD, and CD according to this invention;

FIG. 4 shows another illustrative PMD compensator that includes three optical stages for compensating DGD, SOPMD, and CD according to this invention;

FIG. 5A shows an illustrative optical compensation architecture including an adaptive compensation card and a receiver card integrated into an optical communications network, in which the distortion analyzer of the receiver card provides a feedback signal to the compensation card according to this invention;

FIG. 5B shows an illustrative optical compensation architecture including an adaptive compensation card and a receiver card integrated into an optical communications network, in which the RF splitter of the receiver card provides a signal to the distortion analyzer in the compensation card according to this invention;

FIG. 5C shows an illustrative optical compensation architecture including an adaptive compensation card and a receiver card integrated into an optical communications network, in which the receiver card provides an optical signal to a photodetector in the compensation card according to this invention;

FIG. 6 shows another illustrative optical compensation architecture including a stand-alone adaptive compensation card and a receiver card that can be integrated into a multi-channel optical communications network according to this invention;

FIG. 7 shows a schematic diagram of an illustrative network application for terminal-to-terminal wavelength multiplexed optical communication according to this invention; and

FIG. 8 shows another schematic diagram of an illustrative network application for terminal-to-terminal wavelength multiplexed optical communication according to this invention.

### DETAILED DESCRIPTION OF THE INVENTION

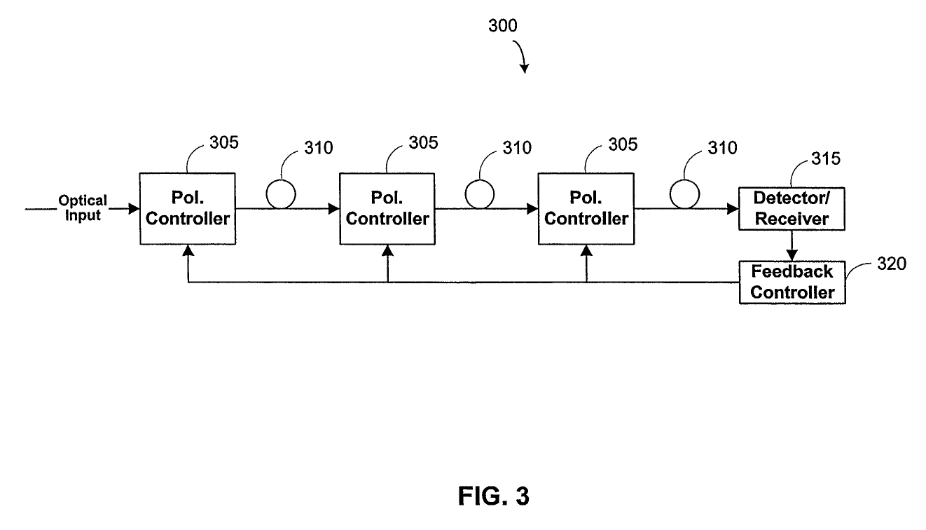

FIG. 3 shows an illustrative embodiment of compensator 300 for compensating for DGD, SOPMD, and CD (hereinafter, “λ-compensator”). Compensator 300 includes at least three variable polarization controllers 305, three birefringent elements (e.g., polarization-maintaining elements, such as polarization-maintaining fibers (hereinafter, “PMFs”)) 310, and feedback controller 320. Each of controllers 305 can include a polarization rotator, a polarization retarder, or a combination of both. Detector/receiver 315 includes a photodetector that converts an optical signal into an electrical one and, as the indicated, can be incorporated into a receiver.

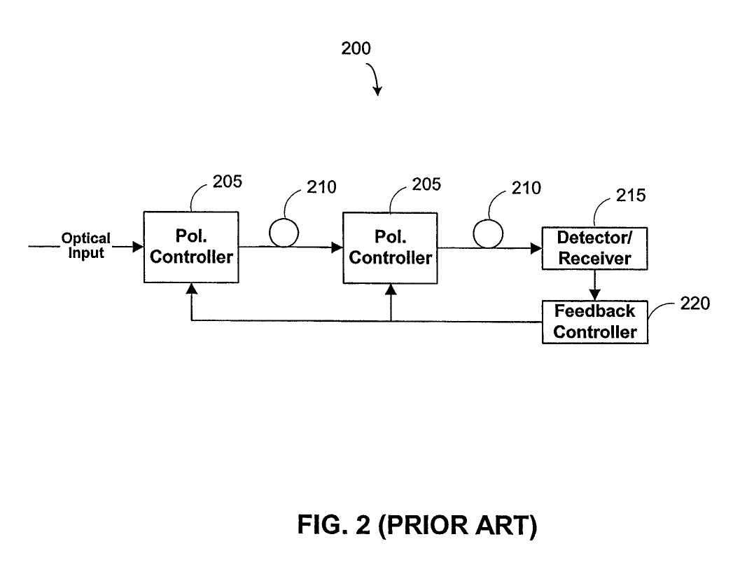

Like the controllers of FIG. 2, controllers 305 can be include a lithium niobate crystal, a lanthanum modified lead zirconate titanate (“PLZT”) ceramic, or a stack of liquid crystal cells to allow limited or endless polarization control. Feedback controller 320 generates a plurality of control signals to control each of controllers 305. And, as explained above, each of controllers 305 can includes one or more liquid crystal cells, each of which can be configured to receive the same or different control voltages.

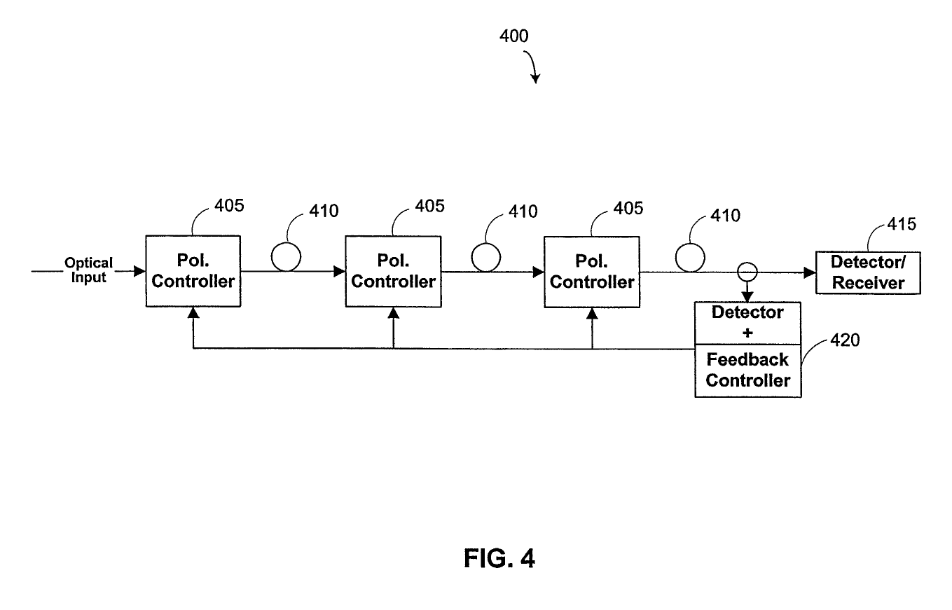

FIG. 4 shows another illustrative embodiment of adaptive optical compensator 400 for compensating for DGD, SOPMD, and CD (hereinafter, “λ-compensator”). Like compensator 300, compensator 400 includes at least three variable optical controllers 405, three birefringent elements 410, and feedback controller 420. In this case, however, the detector in detector/receiver 415 does not provide any feedback signal to feedback controller 420. Rather, feedback controller 420 has a detector integrated within feedback controller 420. In this case, therefore, the optical signal is tapped before being provided to detector/receiver 415. Thus, compensator 400 is a “stand-alone” adaptive optical compensation solution. Controllers 405 are essentially the same as controllers 305.

During operation, and as shown in FIGS. 3 and 4, an optical signal is detected after passing through the compensator components (i.e., controllers 305 and 405 and birefringent elements 310 and 410). The optical signal is then converted by a photodetector (e.g., within detector/receiver 315 or detector/feedback controller 420) and an electrical signal is generated.

The generated electrical signal is then analyzed by a distortion analyzer, which can be any device capable of extracting signal “quality” information and generating a quality-of-bit signal. The quality-of-bit signal can be in the form, for example, of an RF spectrum or a portion thereof. One potential optical distortion analyzer that may be used in accordance with this invention is shown by Fishman U.S. Pat. No. 5,930,414, which is hereby incorporated by reference in its entirety.

Alternatively, the quality-of-bit signal can be a metric of the signal's “eye” opening. It will be appreciated by persons of skill in the art that an “eye” diagram is normally used to visualize how clean a light signal is at a particular transmission point. Low levels of dispersion or distortion generally correspond to a wide-open eye (with a large amount of separation between the voltages for “1” and “0” bits in the center of the signal). Examples of optical distortion analyzers that can be used in accordance with this invention to measure the opening of an eye are taught by Pacek U.S. Provisional Patent Application Nos. 60/221,690, and ______, filed Jul. 31, 2000 and Feb. 15, 2001, having attorney docket Nos. YAFO-6P and YAFO-6PA, respectively, which are hereby incorporated by reference in their entireties.

In yet another alternative, the quality-of-bit signal for PMD can be a measure of the degree of polarization (hereinafter, “DOP”) of the optical signal. The DOP is a function of characteristic Stokes parameters S₁, S₂, and S₃:

$$DOP = \frac{\sqrt{{S}_{1}^{2} + {S}_{2}^{2} + {S}_{3}^{2}}}{{S}_{0}} .$$

where S₀ is the total power. It will be appreciated by a person of ordinary skill in the art that a DOP-based analyzer can be implemented in hardware or software.

After the quality-of-bit signal generated, it can be provided to a feedback controller, which generates control signals for the controllers. Each quality-of-bit signal can be used alone or in combination with each other.

An example of a receiver that can be used in accordance with this invention is sold under Model No. R768, which is available from Lucent Technologies, of Murray Hill, N.J.

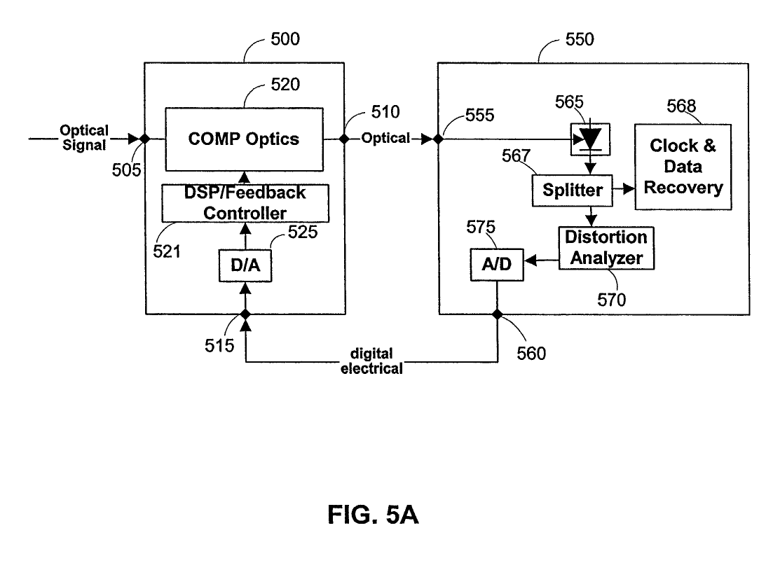

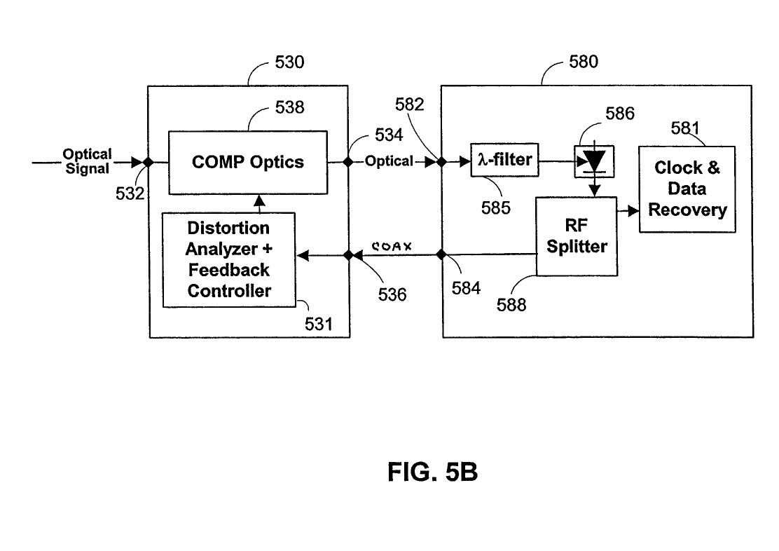

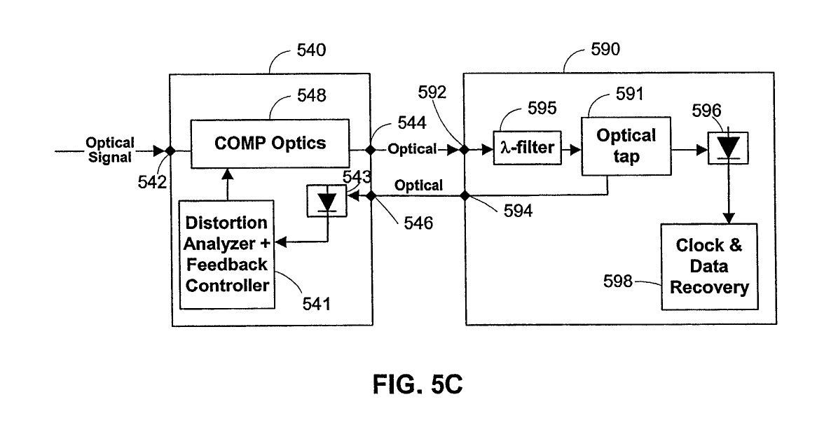

FIG. 5A shows adaptive compensation network card 500 and receiver network card 550 integrated in an optical communications system (not shown). Both cards can be controlled, for example, by microprocessors that may be on or off the cards. Compensator card 500 can include optical input 505, optical output 510, electrical input 515, adaptive compensation optics 520 (e.g., see compensator 300 of FIG. 3), and, preferably, digital-to-analog converter 525 and digital signal processor/feedback controller 521. Receiver card 550 can include optical input 555, electrical output 560, photodetector 565, RF splitter 567, clock and data recovery circuitry 568, optical distortion analyzer (e.g., error detection circuitry) 570, and analog-to-digital converter 575. By integrating the distortion analyzer into the receiver, the compensator card can be simplified and miniaturized.

During operation, compensator card 500 receives an optical signal with DGD, SOPMD, and/or CD at optical input 505, transmits the optical signal through adaptive compensation optics 520, and outputs the optical signal, which has been at least partially compensated by optics 520, through output 510. Compensator card 500 can be, for example, a conventional PMD compensator (e.g., as shown in FIG. 2) or a more fully functional compensator, such as a λ-compensator (e.g., as shown in FIG. 3). Compensation optics is controlled by one or more control signals provided by digital-to-analog converter 525.

After compensator card 500 passes the optical signal to receiver card 550, the optical signal received by card 550 is at least partially compensated. Upon reception, detector 565 generates an electrical signal that is transmitted to RF splitter 567, which divides the signal and provides similar signals to distortion analyzer 570 and clock and data recovery unit 568.

Next, as shown in FIG. 5A, distortion analyzer 570 provides an error signal that can be digitally converted by analog-to-digital converter 575 to provide an electrical feedback control signal. The feedback control signal can then be converted to a digital signal and transmitted back to compensator card 500 (e.g., via a data bus or a system back plane). Once received by compensator card 500, the signal can be converted to an analog signal by digital-to-analog converter 525, and further processed by digital signal processor and feedback controller 521 for controlling the polarization controllers included in adaptive compensation optics 520.

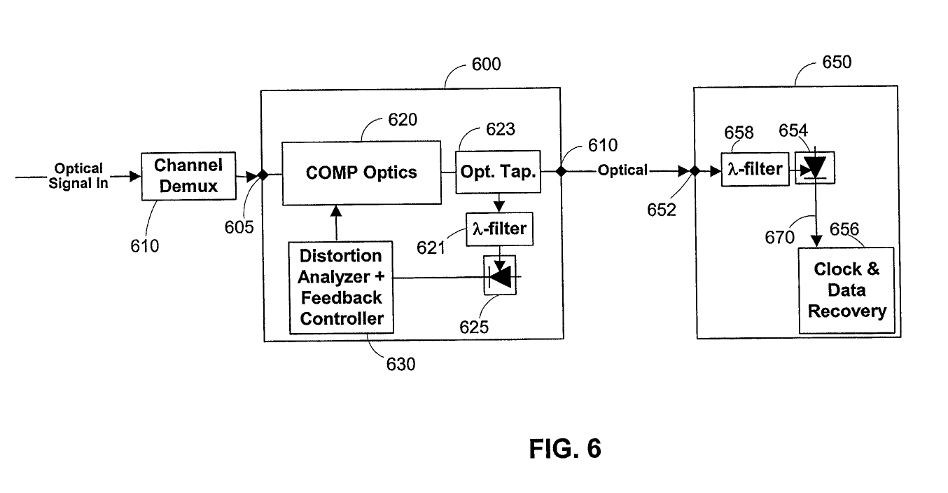

FIGS. 5B, 5C, 5D, and 6 show illustrative embodiments according to this invention in which the distortion analyzer is integrated on the compensation card. In FIGS. 5B and 5C, the receiver card provides an electrical signal and an optical signal, respectively, to the distortion analyzer. This architecture allows multiple external functional modules (e.g., a PMD compensator) to access the signal in real-time, or at a later time. The signal could also be used for in-situ system performance monitoring and provides such modules the ability to measure and remediate optical distortion in the optical signal before any errors occur. The ability to remediate, then, is in contrast to performance monitoring outputs in conventional receivers that supply, for example, the bit error rate of an optical transmission. In such cases, errors are not prevented, they are merely monitored.

FIG. 5B shows adaptive compensation network card 530 and receiver network card 580 integrated in an optical communications system (not shown). The components within cards 530 and 580 are similar to the components within cards 500 and 550, except that they are configured differently. Compensator card 530 can include optical input 532, optical output 534, electrical input 536, adaptive compensation optics 538, and distortion analyzer 531. Analyzer 531 may further include a feedback controller for controlling the polarization controllers within adaptive compensation optics 538. Receiver card 580 can include optical input 582, electrical output 584, photodetector 586, RF splitter 588, and clock and data recovery unit 581.

During operation, compensator card 530 receives an optical signal, transmits the optical signal through adaptive compensation optics 538, and outputs the signal, which has been at least partially compensated, through output 534. Compensator card 530 can be, for example, a conventional PMD compensator (e.g., as shown in FIG. 2) or a more powerful compensator, such as a λ-compensator. Compensation optics 538 is controlled by one or more control signals provided by distortion analyzer 531.

After compensator card 530 passes the optical signal to receiver card 580, detector 586 generates an electrical signal that is transmitted to RF splitter 588, which divides the signal and provides similar signals to distortion analyzer 531 through output 584 and input 536, as well as to clock and data recovery unit 581. Distortion analyzer 531 operates in substantially the same way as analyzer 570. Channel (i.e. wavelength) filter 585 can be inserted anywhere before photodetector 586, including, for example, in receiver card 580 just before photodetector 586.

FIG. 5C shows adaptive compensation network card 540 and receiver network card 590 integrated in an optical communications system (not shown). The components within cards 540 and 590 are again similar to the components within cards 500 and 550, except that they are once again configured differently. Compensator card 540 can include optical input 542, optical output 544, electrical input 546, adaptive compensation optics 548, photodetector 543, and distortion analyzer 541. Analyzer 541 can include a feedback controller that receives the results of the analysis and then controls the polarization controllers in adaptive compensation optics 538.

Receiver card 590 can include optical input 592, optical output 594, optical tap 591, photodetector 596, and clock and data recovery circuitry 598. Card 590 can also include channel filter 595, which can be inserted anywhere before optical tap 591, including, for example, in receiver card 590 just before tap 591.

Operation of compensator card 540 and receiver card 590 is similar to the operation of the configuration shown in FIG. 5B, except that receiver card 590 provides an optical signal to compensator card 540, instead of an electrical signal. Therefore, photodetector 543 is required to convert the optical signal into an electrical signal for further processing.

FIG. 6 shows another illustrative embodiment according to this invention in which the distortion analyzer is integrated on the compensation card. Compensator 600 and receiver card 650 can be integrated in a communications system (not shown). Compensator card 600 can include optical input 605, optical output 610, adaptive compensation optics 620, optical tap 623, photodetector 625, and distortion analyzer 630. Analyzer 630 can include a feedback controller that receives the results of the analysis and then controls the polarization controllers in adaptive compensation optics 620.

Receiver 650 can include optical input 652, photodetector 654, and clock and data recovery unit 656, but includes neither an optical distortion analyzer nor an electrical output coupled to compensator card 600. In this case, compensator card 600 is a stand-alone component and does not require receiver card 650 to be equipped with an electrical or optical tap to provide a feedback signal.

Optical tap 623 generates an optical signal that is converted by photodetector 625 to an electrical signal, which is used for analysis. Analyzer 630 provides a quality-of-bit signal, such as an error signal, for generating feedback control signals to control polarization controllers, such as, a stack of liquid crystal wave plates within compensation optics 620.

When used in a multi-channel communications system, various additional components can be added to the card discussed above. For example, one may add channel demultiplexer 610 upstream from card 600 so that card 600 only compensates for a single channel. Alternatively, or in addition to demultiplexer 610, channel filters 621 and 658 can be inserted in cards 600 and 650.

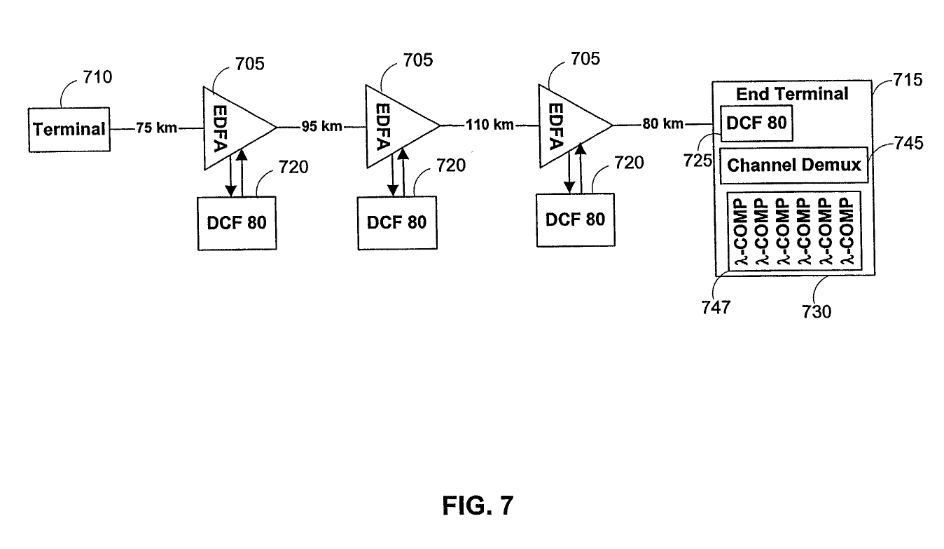

FIG. 7 shows an illustrative network application for terminal-to-terminal wavelength multiplexed optical communication in accordance with the present invention. Optical amplifiers 705, such as erbium doped fiber amplifiers (hereinafter, “EDFAs”), are designed for long haul and regional optical networking applications and can be used with dense wavelength division multiplexing (hereinafter, “DWDM”) networks. EDFAs are sold, for example, by Corning, Inc., of Corning, N.Y. under Model Nos. PureGain™ 2200 and 2300.

As shown, EDFAs 705 can be provided at intervals along a span between source terminal 710 and end terminal 715. Each of EDFAs 705 is combined with fixed dispersion compensation element 720, such as a dispersion compensating fiber (hereinafter, “DCF”), to provide static PMD compensation. The term “DCF-80,” for example, is used to describe a DCF that provides static dispersion compensation for an optical span of fiber that is approximately 80 kilometers long. It will be appreciated that other DCFs can be used depending on the length of the span. Final DCF 725 is provided in end terminal 730. After passing through final DCF 725, wavelength channel demultiplexer 745 demultiplexes the received wavelength multiplexed signal into its corresponding wavelength components.

These components are respectively provided to corresponding λ-compensators 747, each of which can be configured as shown in FIGS. 3 and 4 to provide adaptive optical dispersion compensation. Thus, the embodiment shown in FIG. 7 uses a combination of DCFs (e.g., DCFs 720 and 747) and a plurality of λ-compensators 747 to provide DGD, SOPMD, and CD correction. An advantage of such a configuration is that λ-compensators are easy to install and can be configured as plug and play components; they do not require any modification to existing components.

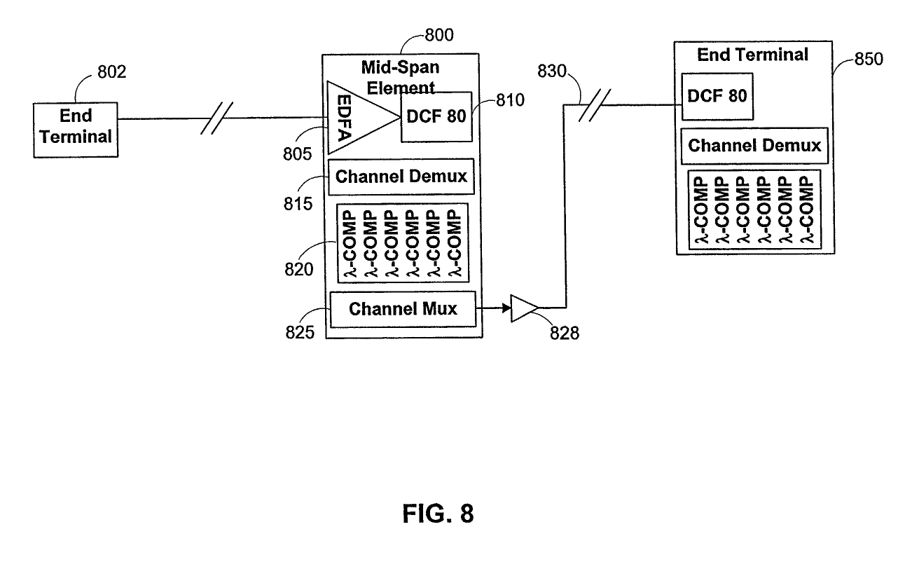

FIG. 8 shows another illustrative network application for terminal-to-terminal wavelength multiplexed optical communication in accordance with the present invention. In this case, in addition to end terminals 802 and 850, the network includes mid-span stand-alone element 800 that provides DGD, SOPMD, and CD compensation. This application is particularly suitable for ultra-long transmission systems and realized compensation without regeneration (i.e., optical/electrical conversion is unnecessary). Any number of spans and optical amplification modules can be used on either side of mid-span element 850.

Mid-span element 800 includes EDFA 805, which amplifies the wavelength multiplexed optical signal and provides an amplified signal to DCF 810. DCF 810 performs static PMD compensation and provides the signal to channel demultiplexer 815, which wavelength demultiplexes the incoming optical signal. Each wavelength component is provided to corresponding λ-compensators 820, which provides further DGD compensation, as well as SOPMD and CD compensation. Multiplexer 825 receives the compensated components and wavelength multiplexes them into a single signal, which, optionally, can be amplified by EDFA 828. That multiplexed signal propagates along optical link 830 towards end terminal 850. End terminal 850 functions much like end terminal 715 of FIG. 7.

Thus, it is seen that by using at least three optical compensation stages, DGD, SOPMD, and CD can be adaptively compensated in a communications system. One skilled in the art will appreciate that the present invention can be practiced by other than the described embodiments, which are presented for purposes of illustration and not of limitation. It will be further appreciated that the present invention is limited only by the claims that follow.

What is claimed is:

1. An apparatus for compensating chromatic dispersion (“CD”), differential group delay (“DGD”), and second order PMD (“SOPMD”), said apparatus comprising:
at least three optical compensators optically coupled in series, wherein said at least three optical compensators comprises a first compensator, at least one intermediate compensator, and a last compensator, and wherein each of said compensators comprises a polarization controller that is optically coupled in series to a birefringent element; and
a feedback controller coupled to a photodetector for receiving said electrical signal generated by said photodetector and coupled to each of said compensators for providing at least one feedback control signal to each of said compensators.

2. The apparatus of claim 1 wherein at least one of said birefringent elements is selected from a group consisting of a polarization maintaining fiber, a calcite crystal, and a combination thereof.

3. The apparatus of claim 1 wherein at least one of said polarization controllers comprises at least one liquid crystal wave plate, and wherein said at least one feedback control signal is coupled to said wave plate.

4. The apparatus of claim 1 wherein said at least three compensators consists of three optical compensators.

5. The apparatus of claim 1 wherein at least one said polarization controllers is selected from a group consisting of a polarization rotator, a polarization retarder, and a combination thereof.

6. The apparatus of claim 1 wherein said at least three optical compensators and said feedback controller are integrated on an optical networking compensation card, and wherein said apparatus includes said photodetector on said compensator card.

7. The apparatus of claim 6 wherein said at least three optical compensators, said feedback controller, and said photodetector are part of a stand-alone optical networking compensator card.

8. The apparatus of claim 6 wherein said compensator card comprises an optical input coupled to an optical tap in a receiver card.

9. The apparatus of claim 6 wherein said feedback controller comprises an optical distortion analyzer that, based on said electrical signal, measures a quality of said optical signal with respect to at least said DGD and CD.

10. The apparatus of claim 8 wherein said analyzer measures a quality of an eye of said optical signal.

11. The apparatus of claim 6 wherein said feedback controller taps an optical output after said last optical compensator.

12. The apparatus of claim 1 wherein said at least three optical compensators and said feedback controller are part of an optical networking compensator card, and wherein said photodetector is external to said card and provides said electrical signal to said card for processing by said feedback controller.

13. The apparatus of claim 12 wherein said compensator card comprises an electrical input for receiving said electrical signal generated by said photodetector, and wherein said input is coupled to a communication channel selected from a group consisting of a system back plane and a data bus.

14. The apparatus of claim 12 wherein said feedback controller comprises an optical distortion analyzer that, based on said electrical signal, measures a quality of said optical signal.

15. The apparatus of claim 14 wherein said analyzer measures a quality of an eye of said optical signal.

16. The apparatus of claim 15 wherein said quality is a dimension of said eye in an eye diagram.

17. An optical communication network comprising:
an optical transmission line;
at least two network terminals linked by said transmission line, at least one of said terminals comprising:
an optical demultiplexer coupled to said broadband optical dispersion compensation element, said demultiplexer for separating multiple optical signals from a multiplexed optical signal, and
a plurality of X-compensators in optical series and downstream from said broadband compensation element and said optical demultiplexer; and
at least one static compensation module along said optical transmission line, said module comprising an optical amplifier and a dispersion compensation element.

18. The network of claim 17 wherein said at least one of said network terminals is a mid-span terminal for an ultra-long network.

19. The network of claim 18 wherein said at least one static compensation module includes at least a first static compensation module that is located upstream from said mid-span terminal and a second static compensation module that is located downstream from said mid-span terminal, and wherein said at least two network terminals further comprises an end-terminal downstream from said second static compensation module.

20. The network of claim 17 wherein said at least one terminal further comprises a static optical dispersion compensation element.
